(19) United States
(12) Patent Application Publication
(10) Pub. No.: US 2026/0340199 A1
(43) Pub. Date: Oct. 29, 2026

(54) SECURE HARDWARE INTERFACE FOR USER KERNEL DATA MOVEMENT ACTIONS

(71) Applicant: Intel Products IP LLC, Santa Clara, CA (US)

(72) Inventors: Andrea Deidda, Leixlip (IE); Alfonso Tarazona Martinez, Celbridge (IE)

(73) Assignee: Intel Products IP LLC, Santa Clara, CA (US)

(21) Appl. No.: 19/705,378

(22) Filed: Jun. 11, 2026

Related U.S. Application Data
(60) Provisional application No. 63/869,636, filed on Aug. 25, 2025.

(51) Int. Cl. G06F 21/71; G06F 9/50

(52) U.S. Cl. CPC G06F 21/71; G06F 9/5077

(57) ABSTRACT

A hardware accelerator includes a data movement engine having submission control circuitry that enables controlled submission of data movement operations by a requester. A submission request includes a virtual resource identifier and a task descriptor address and is associated with hardware-derived metadata identifying the requester. Access control circuitry performs access control based on the submission request and the hardware-derived metadata, such as a context identifier. Resource mapping circuitry determines a physical hardware resource corresponding to a data movement resource based on the virtual resource identifier and the hardware-derived metadata, such as a requester identifier. Based on the determination, the submission request is forwarded to the physical hardware resource to perform the data movement operation. Mapping information may be programmed by a trusted agent, thereby enabling an untrusted requester to initiate data movement through a restricted interface while preserving resource isolation and preventing unauthorized access to configuration resources.

### PRIORITY APPLICATION

This patent application claims priority to and/or receives benefit from US Provisional Application No. 63/869,636, filed on 25 Aug. 2025, titled “ENABLING USER KERNELS DATA MOVEMENT ACTIONS THROUGH A SECURE HARDWARE INTERFACE” (Docket No. AG7237-Z). The US Provisional Application is hereby incorporated by reference in its entirety.

### BACKGROUND

Hardware accelerators, such as neural processing units (NPUs), graphics processing units, and other specialized computing devices, are increasingly used to execute workloads that benefit from high parallelism and low-latency data access. These accelerators often include compute engines that operate on data stored in local or internal memory, while separate data movement hardware transfers data between the internal memory and external memory. Coordinating these compute and data movement operations is important for performance, power efficiency, and resource utilization.

### BRIEF DESCRIPTION OF THE DRAWINGS

Examples will be readily understood by the following detailed description in conjunction with the accompanying drawings. To facilitate this description, like reference numerals designate like structural elements. Examples are illustrated by way of example, and not by way of limitation, in the figures of the accompanying drawings.

FIG. 1 illustrates a neural network (NN) hardware accelerator having a data movement engine with submission control circuitry integrated therein, according to some examples of the disclosure.

FIG. 2 illustrates example implementations of a data movement engine with submission control circuitry, according to some examples of the disclosure.

FIG. 3A illustrates fields of a user submission request, according to some examples of the disclosure.

FIG. 3B illustrates examples of submission metadata, according to some examples of the disclosure.

FIG. 4 illustrates a method for performing access control, according to some examples of the disclosure.

FIG. 5 illustrates a method for performing resource mapping, according to some examples of the disclosure.

FIG. 6 illustrates an example of a trusted agent executing on a control processor, according to some examples of the disclosure.

FIG. 7 illustrates a method for performing start up operations associated with lifecycle management, according to some examples of the disclosure.

FIG. 8 illustrates implementations of dynamic resource management during runtime, according to some examples of the disclosure.

FIG. 9 illustrates a method for performing bring down operations associated with lifecycle management, according to some examples of the disclosure.

FIG. 10 is a flow diagram illustrating a method for operating a data movement engine, according to some examples of the disclosure.

FIG. 11 depicts a block diagram of an exemplary computing device, according to some examples of the disclosure.

### DETAILED DESCRIPTION

### Overview

Programmable hardware accelerators increasingly support user-defined kernels, but such kernels are often not permitted to directly access or control data movement resources such as resources in data movement engines (which may be referred to as direct memory access (DMA) engines). In neural processing units and similar accelerators, compute engines often operate on internal memory, while a data movement engine transfers data between internal memory and external memory. Because DMA resources can access shared memory and affect system-level resource allocation, unrestricted access by user kernels may create security, isolation, and resource management risks. Some approaches often require the compiler to statically schedule data transfers or require trusted firmware to mediate data movement requests. These approaches can be inefficient when user kernel data movement needs are dynamic or not fully known at compile time, and firmware-mediated transfers can add latency, synchronization overhead, and power cost.

The approach provides a hardware-controlled submission path that allows a requester, such as a user kernel executing on a programmable processor on the accelerator, to initiate data movement or perform data movement tasks using the data movement engine without having unrestricted control over and/or access to resources of the data movement engine. In some examples, a submission request from a requester includes a virtual resource identifier and a task descriptor address for a data movement operation. The submission request is also associated with hardware-derived metadata that identifies the requester. Submission control circuitry uses both the requester-provided information and the hardware-derived metadata to decide whether the request may proceed and which physical data movement resource should handle it.

The architecture can be understood as a hardware-enforced key-and-lock mechanism for shared data movement resources. The requester is allowed to present a limited “key” through a restricted interface, but the requester does not define the lock, does not program the key database, and does not directly select the physical resource behind the lock. The key is derived from both user-visible submission information, such as a virtual resource identifier, and hardware-derived metadata, such as requester identity. Trusted software or hardware can control the corresponding lock state by programming mapping information that determines which keys are permitted to open which physical resources.

A first control layer performs access control. For example, hardware-derived metadata may include a context identifier that indicates whether the request is associated with a trusted context or an untrusted context. A trusted context may access configuration resources used to program the data movement engine. An untrusted context may be limited to a restricted submission interface, such as a push pointer register, and may be prevented from accessing configuration registers or suitable privileged control resources. In the key-and-lock analogy, this first layer determines whether the requester is even allowed to approach the submission lock, rather than freely modifying the lock mechanism itself.

A second control layer performs resource mapping. Hardware-derived metadata may include a requester identifier, which is combined with the virtual resource identifier to generate a process identifier. Resource mapping circuitry compares the process identifier against trusted-programmed mapping information to determine whether the requester is authorized to use a physical hardware resource corresponding to the virtual resource identifier. This creates a virtualized resource interface, where the requester can select among virtual resources, but the physical resource assignment remains controlled by trusted software or hardware. In other words, the requester supplies part of the key, hardware supplies the identity bits of the key, and trusted-programmed mapping information determines whether that key matches an authorized physical resource.

When a valid mapping exists, the second control layer forwards the submission request to the selected physical hardware resource. For example, the requester may write the task descriptor address, the virtual resource identifier, and a push or submit indication to a push pointer register. The virtual resource identifier and hardware-derived metadata may be used to determine the selected physical hardware resource, while the task descriptor address from the push pointer register may be forwarded to, or made available to, the selected physical hardware resource. In a data movement engine, the selected physical hardware resource may be a link agent that uses the task descriptor address to fetch or process the task descriptor and to cause a channel to perform the requested transfer between internal memory and an external memory interface. The requester therefore gains a direct, low-latency way to trigger runtime data movement, while the hardware preserves isolation from other requesters and from privileged configuration state. The user-visible virtual resource identifier can remain stable even though the underlying physical resource may be selected, changed, or withheld by trusted control logic.

In some examples, the architecture can report access control failures. If a requester attempts to access a configuration resource that it is not permitted to access, access control circuitry can generate an error. In some examples, the architecture can report mapping failures. If the requester uses the permitted submission path but no authorized physical resource corresponds to the virtual resource identifier and metadata-derived identity, resource mapping circuitry can reject the submission. Status registers and interrupt signaling may record one or more of these conditions and optionally notify a trusted agent. Referring back to the key-and-lock analogy, the access control failure mode corresponds to an unauthorized attempt to modify or bypass the lock, while the mapping failure corresponds to presenting a key that does not match an authorized physical resource.

In some examples, a trusted agent can program the mapping information during startup or application initialization. In some examples, the trusted agent may reprogram the mappings during runtime to add capacity, remove capacity, re-map a requester from one data movement resource to another, consolidate multiple virtual resource identifiers onto a shared resource, or revoke a resource assignment. In some examples, during bring down, the trusted agent may invalidate mapping entries to prevent further use of a resource and free the resource for reassignment. This allows the physical resource allocation to change without requiring the requester to know or control the physical resource assignment.

The resulting architecture improves accelerator flexibility by allowing dynamic user kernel data movement while reducing reliance on static compiler scheduling or firmware intervention. The architecture can improve resource isolation and security by limiting untrusted access to a narrow submission path, deriving identity from hardware metadata rather than user-controlled fields, and routing requests only through trusted-programmed mappings. In effect, the architecture allows user kernels to initiate useful data movement operations while ensuring that physical data movement engine resources remain under trusted, hardware-enforced control.

Although neural processing units provide a representative implementation, the same architecture can be applied in other hardware contexts in which less-trusted requesters require controlled access to shared hardware resources. The principles can be used where virtual resource identifiers, hardware-derived requester metadata, and trusted-programmed mappings provide a secure abstraction over shared physical hardware resources. Moreover, the principles can also be applied to manage shared hardware resources among trusted requesters, not only to isolate untrusted requesters. For example, virtual resource identifiers and trusted-programmed mapping information can allow a system manager to dynamically add, remove, re-map, consolidate, or revoke assignments of shared physical resources as workload demands change. In some examples, the requester may be a user process, firmware thread, virtual machine, accelerator kernel, graphics shader, packet-processing function, storage command processor, or suitable hardware or software agent. The controlled resource may be a resource in a data movement engine, memory copy engine, queue, command processor, accelerator pipeline, link agent, memory channel, input/output resource, or another shared physical resource. In various examples, hardware-derived requester metadata and a requester-provided virtual resource identifier can be evaluated against trusted-programmed mapping information so that the requester interacts with a stable virtual abstraction while trusted control logic determines the authorized physical resource. Thus, the key-and-lock structure is not limited to NPU data movement but can be used generally to expose limited runtime control of shared hardware resources without exposing privileged configuration state or physical resource assignment.

As used herein, a “hardware accelerator” can refer to circuitry configured to perform one or more specialized processing operations more efficiently than a general-purpose processor. Examples of hardware accelerators include neural processing units, graphics processing units, signal processors, media accelerators, packet-processing accelerators, storage accelerators, or suitable fixed-function or programmable accelerator devices.

As used herein, a “compute engine” can refer to circuitry configured to execute computational operations on data. A compute engine can include, for example, a programmable processor, a digital signal processor core, a vector processor, a matrix engine, a tensor engine, a fixed-function compute block, or a combination thereof.

As used herein, a “data movement engine” can refer to circuitry configured to move data between memory locations or between a memory and another hardware component. A data movement engine can include a direct memory access engine, a memory copy engine, a transfer engine, one or more link agents, one or more channels, queues, schedulers, or related control circuitry.

As used herein, a “data movement resource” can refer to a hardware resource used to process, schedule, route, or execute a data movement operation. Examples of data movement resources include link agents, channels, command queues, transfer queues, memory ports, copy engines, channels, memory channels, or suitable hardware resources involved in data transfer.

As used herein, a “submission request” can refer to information provided by a requester to initiate, request, or attempt a hardware operation. A submission request can include, for example, a task descriptor address, a pointer to a task descriptor or linked-list of task descriptors, a virtual resource identifier, a push or trigger indication, control information, or suitable information used to initiate processing by a hardware resource.

As used herein, a “task descriptor” can refer to a data structure that describes an operation to be performed by hardware. For a data movement operation, a task descriptor can identify source information, destination information, transfer size, addressing information, ordering information, access attributes, or suitable control information for performing the data movement operation. In some examples, the task descriptor associated with a submission request identifies movement of neural network data, such as input activations, output activations, weight tensors, bias values, embedding data, attention matrices, key/value tensors, partial sums, scratch data, layer parameters, metadata, or another data structure consumed or produced by one or more compute engines of a neural network accelerator. In some examples, the data movement operation can preload data for a tensor engine, refill local storage for a processing elements (PE) array, evict output tiles generated by multiply-and-accumulate (MAC) units, move intermediate tensors between execution phases, or perform another transfer associated with execution of a neural network workload.

As used herein, a “virtual resource identifier” can refer to an identifier used by a requester to identify a logical, virtual, or abstracted resource, without necessarily identifying a physical hardware resource that will perform the requested operation. A virtual resource identifier can include, for example, a virtual link agent identifier, a virtual channel identifier, a virtual queue identifier, a stream identifier, or another virtualized resource selector.

As used herein, a “physical hardware resource” can refer to an actual hardware resource selected or used to process a submission request. A physical hardware resource can include a physical link agent, channel, queue, data movement engine resource, command processor, memory channel, accelerator pipeline, or suitable hardware resource.

As used herein, “hardware-derived metadata” can refer to metadata associated with a hardware transaction, access, or submission request that is obtained, generated, supplied, appended, snooped, or determined by hardware rather than being freely supplied by a requester as payload data. Hardware-derived metadata can include, for example, a context identifier, requester identifier, security attribute, privilege attribute, bus sideband field, transaction attribute, or suitable hardware-associated identity or access control information.

As used herein, a “context identifier” can refer to information associated with a transaction, request, process, application, address space, protection domain, virtual machine, execution environment, or security context. A context identifier can be used to distinguish trusted and untrusted contexts, enforce isolation among applications or requesters, decorate memory transactions, or determine access rights.

As used herein, a “requester identifier” can refer to information identifying a requester, submitter, initiator, processor, compute engine, kernel, thread, process, or suitable agent associated with a submission request or hardware transaction. A requester identifier can be provided as hardware-derived metadata, including bus sideband metadata, and can be used to generate or select an authorization key, process identifier, or mapping index.

As used herein, a “process identifier” can refer to an identifier generated from or based on one or more fields associated with a requester or submission request. For example, a process identifier can be generated based on a requester identifier and a virtual resource identifier. A process identifier need not correspond to an operating-system process identifier and can function as a hardware authorization key or mapping key.

As used herein, “mapping information” can refer to information used to associate an identifier, key, virtual resource identifier, process identifier, requester identifier, context identifier, or combination thereof with one or more physical hardware resources. Mapping information can be stored in registers, tables, look-up tables, memories, configuration fields, link agent configuration registers, or suitable storage elements.

As used herein, a “trusted agent” can refer to hardware, firmware, software, or a combination thereof that is permitted to program, configure, manage, or control one or more privileged resources. A trusted agent can execute on a control processor, firmware processor, management processor, host processor, secure processor, or suitable trusted execution environment.

As used herein, an “untrusted agent” can refer to hardware, firmware, software, a user kernel, accelerator kernel, application, process, thread, virtual machine, or suitable requester that is not permitted to access one or more privileged configuration resources directly. An untrusted agent may nevertheless be permitted to submit requests through a restricted submission interface.

As used herein, a “restricted submission interface” can refer to an interface through which a requester is permitted to submit a request while being prevented from accessing one or more other configuration or control resources. A restricted submission interface can include, for example, a push pointer register, submission register, doorbell register, command queue, mailbox, or a suitable limited hardware interface.

As used herein, “access control circuitry” can refer to circuitry that determines whether a requester, request, access, or transaction is permitted to access a resource, register, interface, memory region, configuration field, or a suitable hardware component. Access control circuitry can perform access control based on hardware-derived metadata, a context identifier, requester identifier, address, access type, privilege level, security state, or suitable information.

As used herein, “resource mapping circuitry” can refer to circuitry that determines whether a requester or submission request is authorized to use a physical hardware resource and/or determines which physical hardware resource corresponds to a virtual resource identifier. Resource mapping circuitry can compare a process identifier or a suitable key against trusted-programmed mapping information.

As used herein, “submission control circuitry” can refer to circuitry that controls processing of a submission request. Submission control circuitry can include access control circuitry, resource mapping circuitry, routing circuitry, validation circuitry, status circuitry, register interface circuitry, or combinations thereof. Submission control circuitry can accept, reject, route, forward, or process a submission request based on access control and resource mapping determinations.

As used herein, a “configuration resource” can refer to a register, memory, field, table, mapping store, configuration structure, control interface, or suitable resource used to program or configure hardware behavior. Configuration resources can include configuration registers, link agent configuration registers, process identifier mapping registers, mode fields, access control fields, or resource allocation fields.

As used herein, a “status register” can refer to a register or a suitable storage element used to record status, error, violation, rejection, completion, or diagnostic information. A status register can record, for example, an access control error, mapping rejection, no-match condition, full-buffer condition, or a suitable event.

As used herein, an “interrupt” or “interrupt signal” can refer to a signal, message, event, notification, or a suitable indication used to notify an agent or processor of a condition. An interrupt can notify a trusted agent of an access control error, rejected submission, mapping failure, status register update, or a suitable event.

As used herein, “runtime resource reconfiguration” can refer to changing mapping information, allocation information, or configuration information during execution of an application, kernel, process, or workload. Runtime resource reconfiguration can include adding, removing, re-mapping, consolidating, disabling, or revoking assignments of data movement resources.

As used herein, “bring down” can refer to operations performed to remove, revoke, invalidate, drain, complete, disable, or release resource assignments associated with a requester, context, process identifier, application, or workload. Bring down can include invalidating mapping entries, preventing later submissions from using a resource, draining pending tasks, and freeing resources for reassignment.

As used herein, a “processing element” or “PE” can refer to circuitry configured to perform one or more arithmetic, logic, vector, matrix, tensor, or neural network operations. A processing element can include, for example, a multiply-accumulate unit, an arithmetic logic unit, a vector lane, a matrix operation unit, a tensor operation unit, a systolic array element, or combinations thereof.

As used herein, a “multiply-accumulate unit” or “MAC unit” can refer to circuitry configured to perform multiplication and accumulation operations, including integer, floating-point, fixed-point, mixed-precision, quantized, or other arithmetic operations used in neural network inference, training, signal processing, or other accelerated workloads.

As used herein, a “tensor engine” can refer to circuitry configured to perform tensor, matrix, vector, convolution, attention, reduction, accumulation, or related machine learning operations. A tensor engine can include one or more PEs, MAC units, vector lanes, matrix units, systolic array elements, local registers, local buffers, scheduling circuitry, or combinations thereof.

As used herein, a “neural network execution context” can refer to a context associated with execution of a neural network operation, layer, sub-layer, tile, block, kernel instance, workgroup, thread group, wavefront, tensor operation, or other portion of a machine learning workload on one or more compute engines.

As used herein, a “requester” can include a programmable processor, user kernel, accelerator kernel, control thread, workgroup controller, tensor engine controller, PE cluster controller, MAC array controller, or another hardware or software agent associated with execution of an accelerated workload. In some neural network accelerator implementations, the requester can be associated with execution of a kernel on one or more PEs, MAC units, vector engines, matrix engines, or tensor engines, and the requested data movement can support runtime transfer of weights, activations, tensor tiles, or output data for such execution.

As used herein, a “data movement operation” can include movement of weights, activations, feature maps, tensors, tensor tiles, coefficients, partial sums, descriptors, command data, metadata, parameters, or other data used by a neural network accelerator, signal processor, graphics processor, or another hardware accelerator.

### Hardware Accelerator Architecture

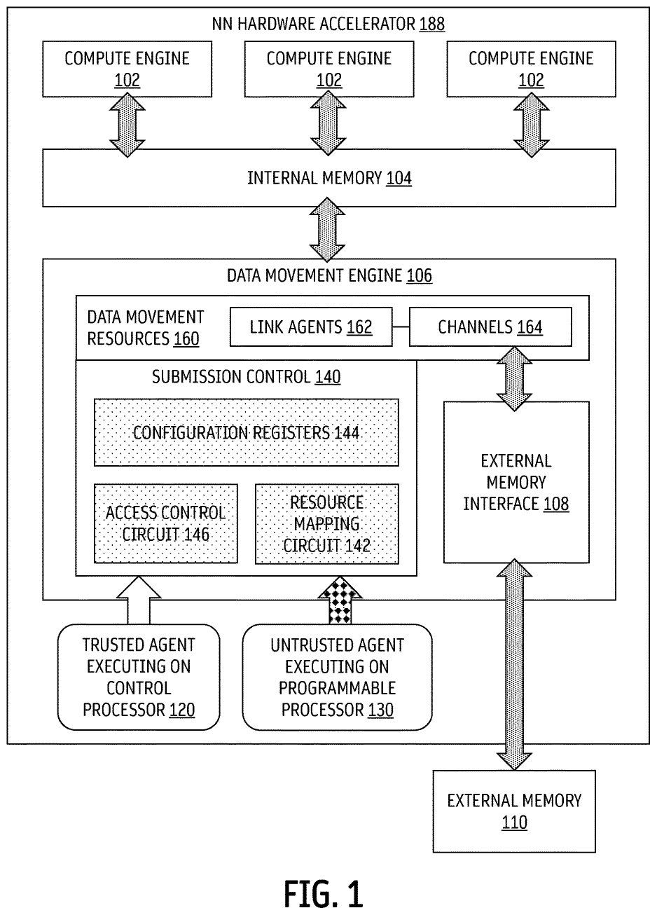

FIG. 1 illustrates NN hardware accelerator 188 having a data movement engine with submission control circuitry integrated therein, according to some examples of the disclosure. NN hardware accelerator 188 comprises one or more compute engines 102, internal memory 104, data movement engine 106, external memory interface 108, trusted agent executing on control processor 120, untrusted agent executing on programmable processor 130, and external memory 110. NN hardware accelerator 188 can execute neural network workloads or suitable workloads using compute engines 102 and data movement engine 106. Compute engines 102 can access internal memory 104 to read or write data used for computation.

In some examples, one or more compute engines 102 comprise neural network execution circuitry, such as one or more PEs, multiply-accumulate (MAC) units, vector execution units, matrix engines, tensor engines, systolic array elements, SIMD lanes, or combinations thereof. In some examples, programmable processor 130 dispatches, controls, or executes user kernels that are associated with neural network operations, tensor operations, convolution operations, attention operations, reduction operations, element-wise operations, activation operations, pooling operations, normalization operations, or combinations thereof. The user kernels can execute using one or more compute engines 102 and can cause operands, weights, activations, partial sums, output feature maps, metadata, or command information to be transferred between internal memory 104 and external memory 110 through data movement engine 106.

In some NPU implementations, compute engines 102 include PE arrays and/or MAC arrays configured to execute tensor workloads. A user kernel executing on programmable processor 130 can coordinate runtime movement of tensor data, weight blocks, activation tiles, partial sums, and output tiles between internal memory 104 and external memory 110 through data movement engine 106. Rather than allowing the user kernel to directly select or configure a physical DMA channel, physical link agent, or physical queue, submission control 140 receives a submission request that includes a task descriptor address and a virtual resource identifier, and uses hardware-derived metadata identifying the requester or execution context to determine whether the request may proceed and which physical hardware resource should receive the request. In this manner, the submission path can be tightly coupled to execution of neural network kernels on PE/MAC-based compute hardware while preserving isolation, trusted control of configuration state, and indirection between virtual submission resources and shared physical data movement resources.

Data movement engine 106 can be coupled between internal memory 104 and external memory interface 108. External memory interface 108 can be coupled to external memory 110 and can provide a path for transferring data between internal memory 104 and external memory 110. In some examples, compute engines 102 access data in external memory 110 through data movement engine 106 rather than through a direct external memory path.

Data movement engine 106 comprises data movement resources 160 and submission control 140. In some representative implementations, data movement resources 160 can include link agents 162 and channels 164. Link agents 162 can receive or process submission requests, task descriptor addresses, or suitable submission information. Channels 164 can perform data movement operations, for example, by transferring data between internal memory 104 and external memory interface 108.

Data movement resources 160 can represent shared physical resources of data movement engine 106 that are used to schedule, route, queue, execute, or support data movement operations. In the illustrated example, data movement resources 160 include link agents 162 and channels 164. Link agents 162 and channels 164 are shown as one implementation of shared data movement resources 160, and other implementations can use different types of shared physical resources, such as transfer queues, command queues, scheduling engines, copy engines, memory channels, stream processors, memory ports, or suitable resources for processing or executing data movement work.

Link agents 162 can operate as front-end scheduling or submission-processing resources of data movement engine 106. For example, a link agent of link agents 162 can receive a submission request or task descriptor address, read or access a task descriptor identified by the task descriptor address, interpret data movement parameters in the task descriptor, and prepare a corresponding data movement task for execution. In some examples, a link agent of link agents 162 can maintain an ordering context, queue, state, or resource allocation associated with a requester, process identifier, virtual resource identifier, or application context. Link agents 162 can provide a resource boundary at which submission requests are accepted, rejected, queued, sequenced, or associated with particular data movement execution resources.

Channels 164 can operate as execution resources of data movement engine 106. For example, a channel of channels 164 can perform the actual transfer of data between a source location and a destination location, such as between internal memory 104 and external memory interface 108. A channel of channels 164 can generate memory read transactions, memory write transactions, address sequences, burst transfers, ordering operations, completion events, or suitable low-level transfer operations based on a data movement task prepared by a link agent of link agents 162. In some examples, multiple channels 164 can operate in parallel to increase throughput, provide bandwidth scaling, or service different link agents 162 or workloads.

In some examples, submission control 140 comprises configuration registers 144. Configuration registers 144 can store configuration information for data movement engine 106. For example, configuration registers 144 can store operating modes, enablement states, control fields, task submission fields, task descriptor or linked-list pointer fields, push pointer registers, link agent settings, channel settings, resource allocation information, mapping information, status information, error indicators, violation indicators, completion indicators, or information used to configure, monitor, or control operation of data movement engine 106. In some examples, configuration registers 144 include one or more registers that are used during ordinary operation of data movement engine 106 to submit, schedule, route, sequence, or execute data movement tasks. For instance, a push pointer register can receive a task descriptor address or task-list pointer and a push indication that triggers a submission attempt and associated hardware checks. In some examples, configuration registers 144 also include link agent configuration registers, process identifier to physical hardware resource mapping information, user mode indicators, and status registers used to indicate rejected submissions, access control errors, no-match conditions, or events.

In some examples, configuration registers 144 can store information used by access control circuit 146 or resource mapping circuit 142. For example, configuration registers 144 can store information used to determine whether a requester is permitted to access a register or interface, whether a data movement resource is enabled for user submissions, whether a process identifier is mapped to a physical hardware resource, or whether an attempted submission has been accepted or rejected. In some examples, configuration registers 144 can be programmed by trusted agent executing on control processor 120 and can be protected from unauthorized access by untrusted agent executing on programmable processor 130. In this manner, NN hardware accelerator 188 can allow untrusted agent executing on programmable processor 130 to initiate data movement operations through a limited submission path while preserving trusted control over configuration resources, status information, resource mappings, and physical data movement resources.

In some examples, submission control 140 includes access control circuit 146 and/or resource mapping circuit 142. Access control circuit 146 and resource mapping circuit 142 can be used together to provide multiple layers of control for submission requests. For example, access control circuit 146 can determine whether a requester is permitted to access a particular register, interface, or suitable configuration resource, and resource mapping circuit 142 can determine which physical hardware resource, if any, is authorized to receive a submission request that has been permitted by access control circuit 146. In other examples, access control circuit 146 can be used without resource mapping circuit 142, such as where submission control 140 enforces register-level or interface-level access restrictions without performing virtual-to-physical resource mapping. In further examples, resource mapping circuit 142 can be used without access control circuit 146, such as where access permissions are enforced by another hardware component or where resource mapping is used to dynamically manage shared physical hardware resources among trusted requesters.

In some examples, access control circuit 146 can perform access control for accesses to submission control 140. In some examples, access control circuit 146 determines whether an access or submission request is associated with a trusted context or an untrusted context based on hardware-derived metadata. For example, the hardware-derived metadata can include a context identifier associated with a transaction, request, requester, process, application, or execution environment. Access control circuit 146 can use the context identifier and, in some examples, information stored in configuration registers 144 to determine whether the requester is permitted to access a register, interface, or suitable configuration resource targeted by the access. Access control circuit 146 can permit trusted agent executing on control processor 120 to access configuration registers 144 and can restrict untrusted agent executing on programmable processor 130 from accessing one or more configuration resources. In some examples, access control circuit 146 restricts untrusted agent executing on programmable processor 130 to a limited submission path, such as a push pointer register, and generates an error when untrusted agent executing on programmable processor 130 attempts to access a configuration resource that is not permitted for the untrusted agent.

In some examples, resource mapping circuit 142 can perform resource mapping for submission requests. In some examples, resource mapping circuit 142 determines a physical hardware resource corresponding to data movement resources 160 based on information in a submission request and hardware-derived metadata. For example, the submission request can include a virtual resource identifier and a task descriptor address, and the hardware-derived metadata can include a requester identifier. Resource mapping circuit 142 can use the virtual resource identifier and the requester identifier to generate or identify a process identifier and can compare the process identifier to mapping information stored in configuration registers 144. The mapping information can be programmed by trusted agent executing on control processor 120 and can associate process identifiers with physical hardware resources, such as link agents 162 or suitable data movement resources 160.

When resource mapping circuit 142 determines that a physical hardware resource is authorized for the submission request, resource mapping circuit 142 (or a routing circuitry in submission control 140) can forward, route, or cause forwarding of the submission request to the determined physical hardware resource. For example, resource mapping circuit 142 can forward the task descriptor address from the submission request to a selected link agent of link agents 162, and the selected link agent of link agents 162 can use the task descriptor address to process the task descriptor and cause one or more channels 164 to perform a data movement operation. When resource mapping circuit 142 determines that no physical hardware resource is authorized for the submission request, resource mapping circuit 142 can reject the submission request, write status information to a status register, raise an interrupt signal, or notify trusted agent executing on control processor 120. Accordingly, access control circuit 146 can control whether a requester may reach a permitted submission path, while resource mapping circuit 142 can control whether the permitted submission request unlocks or resolves to an authorized physical hardware resource.

In some examples, resource mapping circuit 142 can determine which link agent of link agents 162 is authorized to receive a submission request from untrusted agent executing on programmable processor 130. The selected link agent of link agents 162 can then use the task descriptor address included in the submission request to initiate processing of the task descriptor and to cause one or more channels 164 to perform the corresponding data movement operation. Thus, link agents 162 can serve as mapped physical resources exposed through virtual resource identifiers, while channels 164 can serve as transfer execution resources controlled or invoked by the selected link agents 162. Although link agents 162 and channels 164 are used to explain the example of FIG. 1, the resource mapping techniques described herein are not limited to the illustrated architecture. In other examples, resource mapping circuit 142 can map a virtual resource identifier and hardware-derived requester metadata to a queue, channel, copy engine, memory port, command processor, accelerator pipeline, or another shared physical resource. Accordingly, references to link agents 162 and channels 164 can be understood as illustrative of one data movement engine architecture in which shared physical resources are allocated, isolated, and dynamically managed through trusted-programmed mapping information.

In some examples, trusted agent executing on control processor 120 can program configuration registers 144, including mapping information used by resource mapping circuit 142. Control processor 120 can be a management processor, firmware processor, supervisory processor, host-controlled processor, secure processor, or a processor that executes software or firmware having authority to configure data movement engine 106. Trusted agent executing on control processor 120 can be considered trusted because it is permitted by hardware, firmware, system software, privilege configuration, security policy, or a control mechanism to program configuration resources that affect operation of data movement engine 106, including resource mappings, access control settings, link agent settings, channel settings, status controls, or configuration state.

Untrusted agent executing on programmable processor 130 can submit a submission request through a restricted path into submission control 140. Programmable processor 130 can be a compute processor, accelerator processor, digital signal processor core, programmable compute engine, user kernel processor, shader processor, vector processor, or a processor configured to execute application code, user code, kernel code, or suitable workload-specific code. Untrusted agent executing on programmable processor 130 can be considered untrusted, at least relative to trusted agent executing on control processor 120, because untrusted agent is not permitted to directly program one or more configuration resources of data movement engine 106. For example, untrusted agent may be allowed to request data movement through a limited submission path but may be prevented from programming resource mappings, changing link agent or channel configuration, modifying access control settings, or selecting physical data movement resources directly.

In some examples, data movement requests submitted through submission control 140 are associated with execution of a neural network layer, sub-layer, tile, stripe, block, tensor fragment, workgroup, wavefront, thread group, kernel instance, or other portion of an accelerator workload mapped to one or more compute engines 102. For example, a user kernel executing on programmable processor 130 may request movement of weights, activations, coefficients, descriptors, or output data for consumption by one or more PEs, MAC units, vector units, matrix engines, or tensor engines, while remaining restricted from directly programming physical data movement resources 160.

In some examples, untrusted agent executing on programmable processor 130 provides a virtual resource identifier and task descriptor address, while submission control 140 uses hardware-derived metadata to determine whether the submission request is permitted and which physical hardware resource should perform the requested data movement operation. The trust distinction therefore need not require that the untrusted agent is malicious or unreliable. Rather, the distinction can indicate different hardware privileges or different degrees of authority over configuration resources. A trusted agent can establish the resource allocation and protection policy, while an untrusted agent can initiate data movement only through a controlled interface and only to the extent permitted by access control circuit 146 and/or resource mapping circuit 142.

### Submission Control Architecture

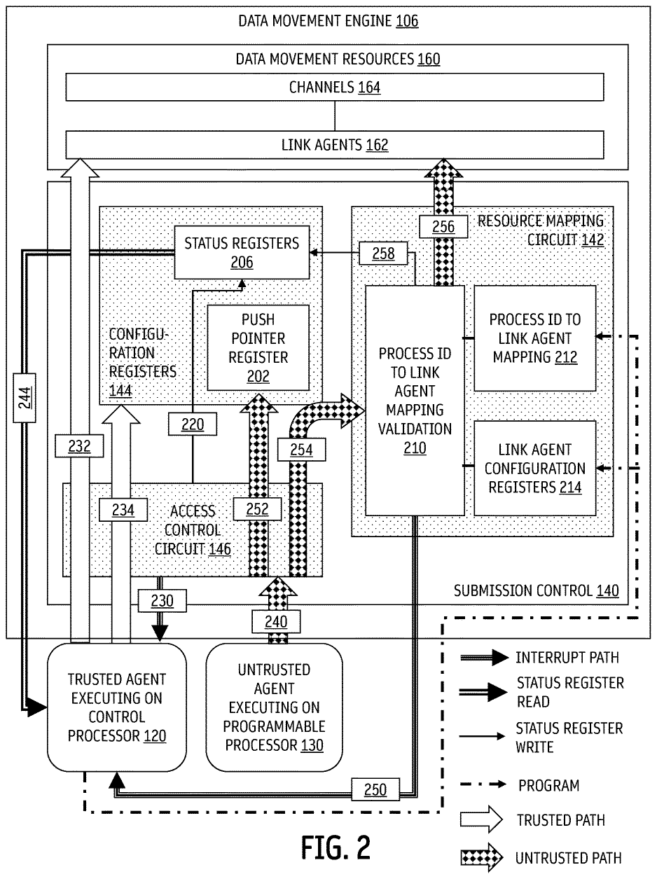

FIG. 2 illustrates example implementations of data movement engine 106 with submission control 140, according to some examples of the disclosure. Data movement engine 106 can include submission control 140 and data movement resources 160. In some examples, data movement resources 160 can include channels 164 and link agents 162. As discussed above, link agents 162 and channels 164 are examples of physical data movement resources, and other examples can include queues, command processors, transfer engines, memory channels, ports, scheduling resources, or suitable shared hardware resources used to process or execute data movement work.

Submission control 140 can include one or more of access control circuit 146, configuration registers 144, push pointer register 202, status registers 206, resource mapping circuit 142, process identifier (ID) to link agent mapping validation 210, process ID to link agent mapping 212, and link agent configuration registers 214. Although process ID to link agent mapping 212 and link agent configuration registers 214 are shown separately from configuration registers 144 for ease of illustration, process ID to link agent mapping 212 and link agent configuration registers 214 may be implemented as portions of configuration registers 144, portions of a configuration/status register space, separate register files, table structures, memory arrays, content-addressable memory structures, look-up tables, programmable logic state, or suitable storage or control structures accessible to submission control 140. Similarly, status registers 206 can be implemented as part of configuration registers 144 or as part of a broader configuration/status register space of submission control 140.

In some examples, trusted agent executing on control processor 120 can interact with submission control 140 through one or more trusted paths. In some examples, trusted agent executing on control processor 120 uses trusted push path 232 to directly control data movement resources 160. For example, trusted push path 232 can allow trusted agent executing on control processor 120 to submit, push, or provide data movement work directly to link agents 162 or suitable data movement resources 160 without being subject to restrictions applied to an untrusted submission path. Trusted push path 232 can correspond to a trusted submission mechanism used by trusted firmware or another privileged agent to control data movement operations. In some examples, trusted agent executing on control processor 120 can use programming path 234 to program configuration registers 144. Configuration registers 144 can store operating state, control fields, mode fields, task submission fields, resource allocation information, access control information, status or indicator information, or suitable configuration information used by data movement engine 106. In some examples, programming path 234 can be used to program information that controls access control circuit 146, resource mapping circuit 142, process ID to link agent mapping 212, or link agent configuration registers 214. Trusted agent executing on control processor 120 can therefore establish which contexts, requesters, process identifiers, virtual resource identifiers, or request attributes are permitted to use particular physical data movement resources.

In some examples, untrusted agent executing on programmable processor 130 can interact with submission control 140 through untrusted path 240. Untrusted path 240 can represent an initial access or submission path from untrusted agent executing on programmable processor 130 into submission control 140 before access control circuit 146 determines whether the access is permitted. The access or submission request can be associated with hardware-derived metadata identifying untrusted agent executing on programmable processor 130. For example, hardware-derived metadata can include a context identifier, requester identifier, security attribute, privilege attribute, bus sideband field, transaction attribute, or metadata associated with the access or submission request.

In some examples, access control circuit 146 can evaluate untrusted path 240 to determine whether the access is permitted. In some examples, access control circuit 146 determines whether the access is associated with a trusted context or an untrusted context based on a context identifier included in the hardware-derived metadata. If access control circuit 146 determines that the requester is permitted to write to push pointer register 202, permitted write path 252 can be used to write information to push pointer register 202. In some examples, writing data to push pointer register 202 can be permitted for untrusted submissions, while other accesses by untrusted agent executing on programmable processor 130 remain restricted or prohibited. In some examples, writing data to push pointer register 202 by untrusted submissions is always allowed, thus bypassing access control circuit 146.

Push pointer register 202 can receive information from an agent used to initiate a submission request. For example, push pointer register 202 can receive a task descriptor address, a virtual resource identifier, a push or submit indication, or suitable submission information. The task descriptor address can identify a task descriptor, a linked-list of task descriptors, or a memory-resident structure describing a data movement operation. The virtual resource identifier can identify a virtualized resource selected by untrusted agent executing on programmable processor 130, without exposing or giving control over a corresponding physical data movement resource.

In some examples, access control circuit 146 can generate an access control error when untrusted agent executing on programmable processor 130 attempts to access a configuration resource that the untrusted agent is not permitted to access. For example, access control circuit 146 can block an unauthorized attempt to program configuration registers 144, process ID to link agent mapping 212, link agent configuration registers 214, or a protected configuration resource. In some examples, in response to detecting such an access control error, access control circuit 146 can write an indication of the error to status registers 206 via status register write path 220. In some examples, access control circuit 146 can notify trusted agent executing on control processor 120 using interrupt path 230.

After access control circuit 146 permits an untrusted submission request, permitted submission path 254 can carry the untrusted submission request, or information derived from the untrusted submission request, toward process ID to link agent mapping validation 210 for resource mapping. Permitted submission path 254 need not originate from push pointer register 202 in all implementations. In some examples, information used in process ID to link agent mapping validation 210 can be obtained from push pointer register 202, such as a virtual resource identifier, task descriptor address, or push indication. In other examples, information used in process ID to link agent mapping validation 210 can be obtained from another portion of the permitted submission request, from transaction metadata, or from other submission control state.

In some examples, access control circuit 146 can evaluate a context identifier associated with an access to determine whether the access is associated with a global context or a non-global context. A global context identifier can indicate a trusted access, such as an access initiated by trusted agent executing on control processor 120, and access control circuit 146 can permit the global context access to read from or write to configuration registers 144 or suitable configuration resources of data movement engine 106. A non-global context identifier can indicate a user or non-trusted access, such as an access initiated by untrusted agent executing on programmable processor 130, and access control circuit 146 can restrict the non-global context access to one or more limited submission resources, such as push pointer register 202. In some examples, access control circuit 146 can compare a context identifier against one or more stored lists of context identifiers, such as a list of permitted context identifiers, a list of restricted context identifiers, or both. In some examples, different context identifiers or groups of context identifiers can be associated with different permission profiles, such as full configuration access, read-only status access, restricted submission access, access to selected configuration registers, or no access. If an access associated with a non-global context identifier attempts to access configuration registers 144 or another protected configuration resource instead of a permitted submission resource, access control circuit 146 can block the access, generate an error response, write an indication to status registers 206, raise an interrupt to trusted agent executing on control processor 120, or perform a combination thereof.

In some examples, resource mapping circuit 142 can perform process ID to link agent mapping validation 210. In some examples, resource mapping circuit 142 generates or identifies a process identifier based on a requester identifier from hardware-derived metadata and a virtual resource identifier associated with the submission request. Resource mapping circuit 142 can compare the process identifier against process ID to link agent mapping 212. Process ID to link agent mapping 212 can associate process identifiers with physical data movement resources, such as link agents 162. Link agent configuration registers 214 can store configuration information for link agents 162, such as mode information, enablement information, user mode information, queue or buffer information, or suitable settings used to determine whether a particular link agent in link agents 162 can receive a submission request from an untrusted agent (e.g., untrusted agent executing on programmable processor 130).

In some examples, when process ID to link agent mapping validation 210 determines that the process identifier corresponds to an authorized physical data movement resource, accepted submission path 256 can forward the submission request to a selected link agent of link agents 162. In some examples, resource mapping circuit 142 performs both the mapping determination and the forwarding or routing of the submission request to a selected link agent of link agents 162. For example, resource mapping circuit 142 can forward the task descriptor address, virtual resource identifier, push indication, or suitable submission information to a selected link agent of link agents 162. A selected link agent of link agents 162 can then use the task descriptor address to fetch, read, or process the task descriptor and can cause one or more channels 164 to perform the corresponding data movement operation.

For example, resource mapping circuit 142 can receive a permitted submission request associated with a requester identifier of R1 and a virtual resource identifier of VLA0. Resource mapping circuit 142 can generate a process identifier, such as a value based on R1 and VLA0, and can compare the generated process identifier against entries of process ID to link agent mapping 212. Process ID to link agent mapping 212 may include an entry indicating that the generated process identifier is assigned to a particular physical link agent, such as link agent LA2. In some examples, resource mapping circuit 142 can then consult link agent configuration registers 214 for LA2 to determine whether LA2 is enabled, whether LA2 is configured to accept untrusted submissions, whether LA2 is available to receive a submission, or whether another link agent condition is satisfied. If the generated process identifier matches the entry in process ID to link agent mapping 212 and the corresponding configuration information for LA2 indicates that LA2 is eligible to receive the submission request, resource mapping circuit 142 can determine that LA2 is the authorized physical hardware resource and can forward the submission request, including the task descriptor address, to LA2. If the generated process identifier does not match an entry, or if the mapped link agent is not enabled or not eligible according to link agent configuration registers 214, resource mapping circuit 142 can reject the submission request.

When process ID to link agent mapping validation 210 determines that no physical data movement resource is authorized for the submission request, resource mapping circuit 142 can reject the submission request. For example, a rejection can occur when no entry in process ID to link agent mapping 212 corresponds to a process identifier generated for the submission request, when the selected link agent of link agents 162 is not enabled for the type of request, when link agent configuration registers 214 indicate that the corresponding physical resource is unavailable, or when another mapping condition is not satisfied. In response to a rejection or no-match condition, resource mapping circuit 142 can write status information to status registers 206 via status register write path 258 or another status write path, and can generate an interrupt to trusted agent executing on control processor 120 via interrupt path 250.

In some examples, trusted agent executing on control processor 120 can read status registers 206 through status register read path 244. For example, trusted agent executing on control processor 120 can read status registers 206 after receiving an interrupt through interrupt path 230 or interrupt path 250, or as part of periodic status monitoring. Status registers 206 can store indications of access control errors, mapping-based rejections, no-match conditions, rejected submissions, completion status, full-buffer conditions, or events associated with data movement engine 106. Based on information read from status registers 206, trusted agent executing on control processor 120 can diagnose errors, adjust configuration registers 144, reprogram process ID to link agent mapping 212, update link agent configuration registers 214, or perform management operations.

Status registers 206 and interrupt signaling can provide complementary reporting mechanisms. Status registers 206 can store information describing an event, such as an access control error, rejected submission, no-match condition, full-buffer condition, completion event, requester identifier, process identifier, virtual resource identifier, or error code. An interrupt signal can notify trusted agent executing on control processor 120 that an event has occurred. In some examples, trusted agent executing on control processor 120 receives the interrupt signal and then reads status registers 206 to determine the type, source, or context of the event. In other examples, trusted agent executing on control processor 120 can poll status registers 206 without receiving an interrupt signal.

In this manner, FIG. 2 illustrates two complementary forms of control. Access control circuit 146 can control whether a requester is permitted to access a register, interface, or configuration resource of submission control 140. Resource mapping circuit 142 can control whether a permitted submission request resolves to an authorized physical data movement resource. Access control circuit 146 and resource mapping circuit 142 can be used together, as shown, to provide layered protection for untrusted submissions. In other implementations, access control circuit 146 can be used without resource mapping circuit 142, or resource mapping circuit 142 can be used without access control circuit 146, such as when access permissions are enforced elsewhere or when resource mapping is used to dynamically manage shared physical resources among trusted requesters.

Although several examples describe link agents 162 and channels 164, the techniques described herein are not limited to a data movement engine architecture that uses link agents and channels. A physical hardware resource selected by resource mapping circuit 142 may include a queue, command processor, transfer engine, channel, memory port, scheduling resource, stream resource, copy engine, or another hardware resource used to process, route, schedule, or execute data movement work. Similarly, a virtual resource identifier may identify a virtual queue, virtual channel, virtual stream, virtual transfer resource, or another virtualized resource abstraction. Thus, references to a virtual link agent identifier and a physical link agent may describe one example implementation of a broader virtual-to-physical resource mapping technique.

Although several examples describe requester isolation for an untrusted agent, the same mapping principles can also be used to manage shared resources among trusted requesters or among requesters having different permission levels. For example, trusted software can use virtual resource identifiers and trusted-programmed mapping information to add, remove, re-map, consolidate, or revoke assignments of shared physical resources as workload demand changes. In such examples, resource mapping circuit 142 can provide a layer of indirection between a requester-visible virtual resource and an assigned physical resource, even when the requester is trusted to submit work. This can allow physical resources to be dynamically reallocated without changing the virtual resource identifiers used by requesters.

In some examples, access control and resource mapping can be performed in different orders or by different hardware blocks. For example, access control circuit 146 can first determine whether a requester is permitted to access a restricted submission interface, and resource mapping circuit 142 can then determine whether the permitted submission request maps to an authorized physical hardware resource. In another example, resource mapping circuit 142 can perform the resource determination and forwarding, while access permissions are enforced by a separate firewall, bus fabric, register interface, privilege checker, or security controller. In still another example, access control circuit 146 and resource mapping circuit 142 can be integrated into a common submission control circuit that performs both permission checking and resource selection.

### Submission Request and Metadata Structure

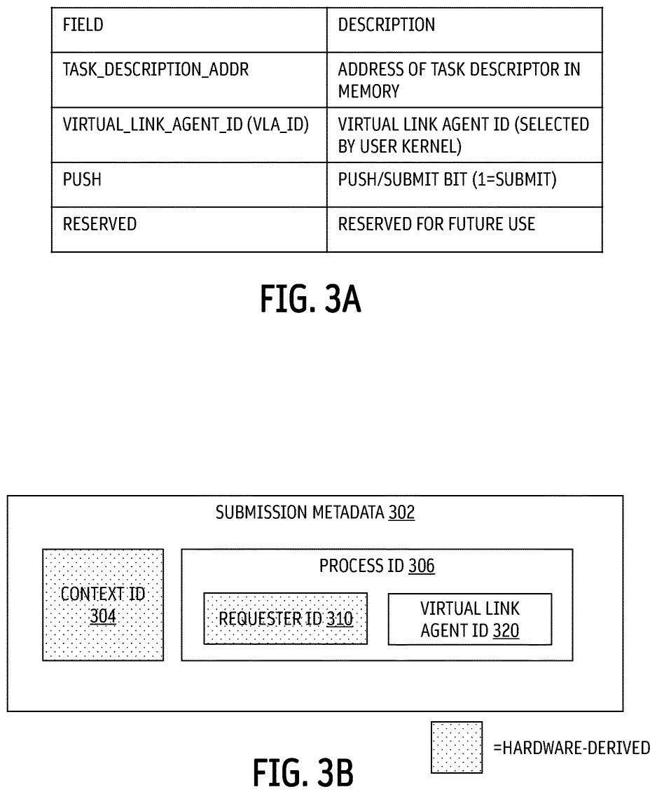

FIG. 3A illustrates example fields of a user submission request. The user submission request can include TASK_DESCRIPTION_ADDR, which identifies an address of a task descriptor in memory, and VIRTUAL_LINK_AGENT_ID (VLA_ID), which identifies a virtual link agent selected by a user kernel. In some examples, the user submission request can include a PUSH field, such as a push or submit bit that indicates whether the submission request should be submitted. In some examples, the user submission request can include one or more RESERVED fields for future use or implementation-specific information.

In some examples, one or more virtual link agent identifiers can be allocated to a user kernel during startup, initialization, or another resource allocation phase. For example, trusted agent executing on control processor 120 can assign different virtual link agent identifiers to the user kernel and can program mapping information that associates those virtual link agent identifiers, alone or in combination with hardware-derived metadata identifying the user kernel, with corresponding physical data movement resources. During runtime, the user kernel can include a selected virtual link agent identifier in the user submission request to indicate which allocated virtual data movement resource should be used for the requested data movement operation.

FIG. 3B illustrates example submission metadata 302 associated with a submission request. Submission metadata 302 can include context ID 304 and process ID 306. As indicated by the shaded pattern, context ID 304 and requester ID 310 can be hardware-derived, for example from transaction metadata or sideband information associated with the submission request, rather than being freely supplied by the user kernel (e.g., in the submission request).

Process ID 306 can include requester ID 310 and virtual link agent ID 320. Requester ID 310 can identify the requester, submitter, programmable processor, compute engine, user kernel, or an agent associated with the submission request. Virtual link agent ID 320 can correspond to the virtual link agent identifier selected in the user submission request. In some examples, process ID 306 can be generated based on requester ID 310 and virtual link agent ID 320 and can be used as a key for resource mapping, while context ID 304 can be used for access control decisions, such as determining whether the submission request is associated with a trusted context or an untrusted context.

One or more parts of submission metadata 302 can be used as one or more keys for controlling access to data movement resources. For example, context ID 304 can operate as an access control key used by access control circuit 146 to determine whether the requester is associated with a trusted context, a user context, or another permission profile. A trusted or global context ID may unlock broader access to configuration registers, while a user or non-global context ID may unlock only a restricted submission path, such as access to a push pointer register.

In some examples, process ID 306 can operate as a resource mapping key used by resource mapping circuit 142 to determine whether the submission request corresponds to an authorized physical data movement resource. In some examples, process ID 306 is formed from requester ID 310 and virtual link agent ID 320. Requester ID 310 identifies the requester from hardware-derived metadata, while virtual link agent ID 320 identifies the virtual resource selected by the user kernel. Together, these values form a key that can be compared against trusted-programmed mapping information, such as process ID to link agent mapping 212. If the key matches an authorized mapping, the submission request can be forwarded to the mapped physical resource. If the key does not match, the submission request can be rejected.

In some examples, process ID 306 can be used as a hardware mapping key and need not correspond to an operating-system process identifier. In some examples, the process identifier is generated from a requester identifier obtained from hardware-derived metadata and a virtual resource identifier supplied in a submission request. Process ID 306 can therefore identify a particular combination of requester and virtual resource, rather than merely identifying a software process. Resource mapping circuit 142, as illustrated in FIGS. 1-2, can compare process ID 306 against trusted-programmed mapping information to determine whether the submission request is authorized for a physical hardware resource.

Hardware-derived metadata can be distinguished from payload fields supplied by a requester. For example, a requester may supply a task descriptor address, virtual resource identifier, push indication, or related submission information through a submission request. By contrast, hardware-derived metadata can be supplied, appended, decoded, snooped, or generated by hardware-associated with the transaction carrying the submission request. Hardware-derived metadata can include a context identifier, requester identifier, privilege attribute, security attribute, bus sideband value, transaction source identifier, or another value that is not freely programmable by the requester as payload. Using hardware-derived metadata can prevent a requester from self-identifying as a different requester or context when attempting to access a protected configuration resource or mapped physical hardware resource.

### Access Control and Resource Mapping

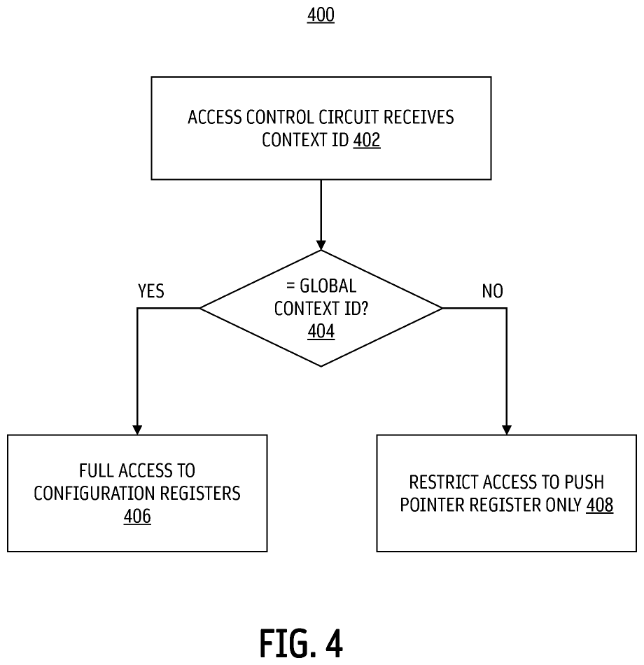

FIG. 4 illustrates method 400 for performing access control based on a context ID, according to some examples of the disclosure.

In 402, access control circuit 146, as illustrated in FIGS. 1-2, receives a context ID. Performing this operation can include receiving, extracting, reading, or obtaining a context identifier from hardware-derived metadata associated with an access or submission request. In some examples, the context ID is not supplied as freely programmable user payload, but is instead provided as transaction metadata, sideband metadata, or suitable hardware-derived information associated with the requester.

In 404, access control circuit 146 determines whether the context ID received in 402 corresponds to a global context ID. Performing this operation can include comparing the context ID received in 402 to a global context identifier value, a trusted context value, or another value indicating a context having elevated access permissions. In some examples, a global context ID corresponds to trusted agent executing on control processor 120, while a non-global context ID corresponds to untrusted agent executing on programmable processor 130.

If access control circuit 146 determines that the context ID received in 402 corresponds to the global context ID, method 400 proceeds to 406. In 406, access control circuit 146 permits full access to configuration registers. Performing this operation can include allowing the requester associated with the global context ID to read from, write to, or access configuration registers 144 or suitable configuration resources of data movement engine 106. In some examples, such access enables trusted agent executing on control processor 120 to program operating modes, resource mappings, link agent configuration information, status/control fields, or suitable configuration information used by submission control 140.

If access control circuit 146 determines that the context ID received in 402 does not correspond to the global context ID, method 400 proceeds to 408. In 408, access control circuit 146 restricts access to push pointer register 202 only. Performing this operation can include allowing the requester associated with the non-global context ID to submit a limited data movement request through push pointer register 202 while preventing access to configuration registers 144 or suitable protected configuration resources. In some examples, restricting access in this manner allows an untrusted requester to initiate a permitted submission path without permitting the untrusted requester to program the configuration state or physical resource mappings of data movement engine 106.

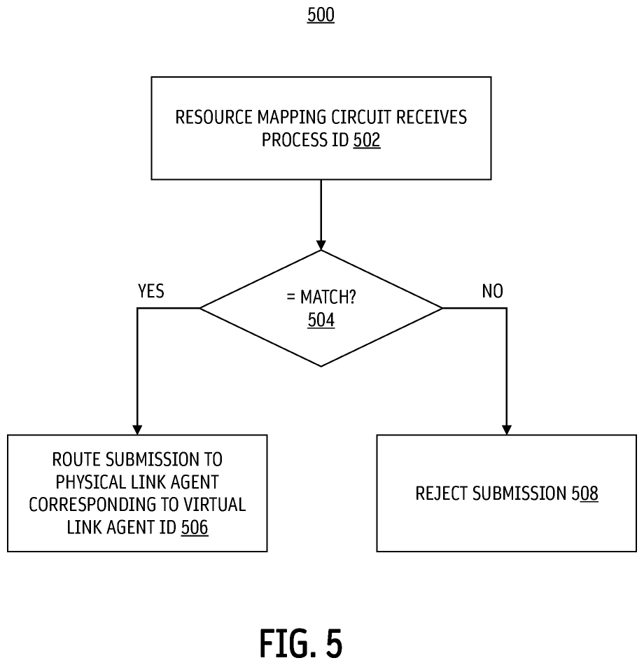

FIG. 5 illustrates method 500 for performing resource mapping, according to some examples of the disclosure. Method 500 can be performed by resource mapping circuit 142 of submission control 140 as illustrated in FIGS. 1-2 after a submission request has been permitted by access control circuit 146 as illustrated in FIGS. 1-2. Method 500 can determine whether a process identifier associated with the submission request corresponds to an authorized physical hardware resource, such as a physical link agent.

In 502, resource mapping circuit 142 receives a process ID. Performing this operation can include receiving, generating, identifying, or obtaining a process identifier associated with a submission request. In some examples, the process ID received in 502 is generated based on hardware-derived metadata, such as a requester identifier, and information in the submission request, such as a virtual link agent identifier. The process ID received in 502 can operate as a resource mapping key for determining whether the requester is authorized to use a physical data movement resource.

In 504, resource mapping circuit 142 determines whether the process ID received in 502 matches the mapping information. Performing this operation can include comparing the process ID received in 502 against process ID to link agent mapping 212 or suitable mapping information programmed by a trusted agent. In some examples, the mapping information associates process identifiers with physical link agents or one or more physical data movement resources. A match can indicate that the process ID received in 502 is authorized for a physical link agent corresponding to the virtual link agent identifier associated with the submission request.

If resource mapping circuit 142 determines that a match exists, method 500 proceeds to 506. In 506, resource mapping circuit 142 routes the submission to a physical link agent corresponding to the virtual link agent ID. Performing this operation can include forwarding the submission request, task descriptor address, push indication, or suitable submission information to the matched physical link agent. In some examples, the physical link agent can use the task descriptor address to fetch or process a task descriptor and cause a channel of data movement engine 106 to perform the requested data movement operation.

If resource mapping circuit 142 determines that no match exists, method 500 proceeds to 508. In 508, resource mapping circuit 142 rejects the submission. Performing this operation can include preventing the submission request from being forwarded to a physical link agent. In some examples, rejecting the submission can include writing rejection information to a status register, raising an interrupt signal to notify a trusted agent, returning an error indication, or reporting that no authorized physical hardware resource corresponds to the submission request.

### Resources Lifecycle Management

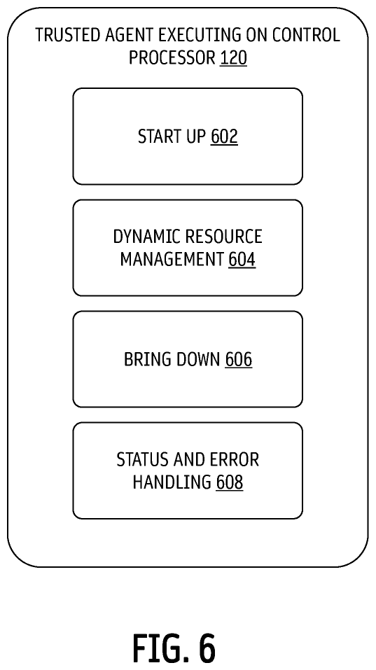

FIG. 6 illustrates an example of a trusted agent executing on control processor 120, according to some examples of the disclosure. In some examples, trusted agent executing on control processor 120 can perform operations for managing access to, configuration of, and lifecycle control of data movement resources of data movement engine 106.

In some examples, trusted agent executing on control processor 120 can perform start up 602. Start up 602 can include initialization or bring-up operations for data movement engine 106, such as programming configuration information, establishing mapping information, allocating one or more data movement resources, enabling selected resources for user submissions, or preparing submission control 140 for operation.

In some examples, trusted agent executing on control processor 120 can perform dynamic resource management 604. Dynamic resource management 604 can include modifying, during runtime, how shared data movement resources are assigned, mapped, consolidated, reduced, expanded, disabled, or otherwise managed. In some examples, dynamic resource management 604 can allow trusted agent executing on control processor 120 to adjust physical resource allocation without requiring an untrusted agent to know or control the underlying physical data movement resources.

In some examples, trusted agent executing on control processor 120 can perform bring down 606. Bring down 606 can include invalidating or removing mapping information, disabling user mode access to one or more data movement resources, draining or completing pending tasks, freeing resources for reassignment, or otherwise revoking access associated with a requester, process identifier, virtual resource identifier, application, workload, or context.

In some examples, trusted agent executing on control processor 120 can perform status and error handling 608. Status and error handling 608 can include receiving interrupts, reading status registers, identifying access control errors, identifying mapping-based rejections, responding to no-match conditions, updating configuration information, or taking corrective action based on status information generated by data movement engine 106.

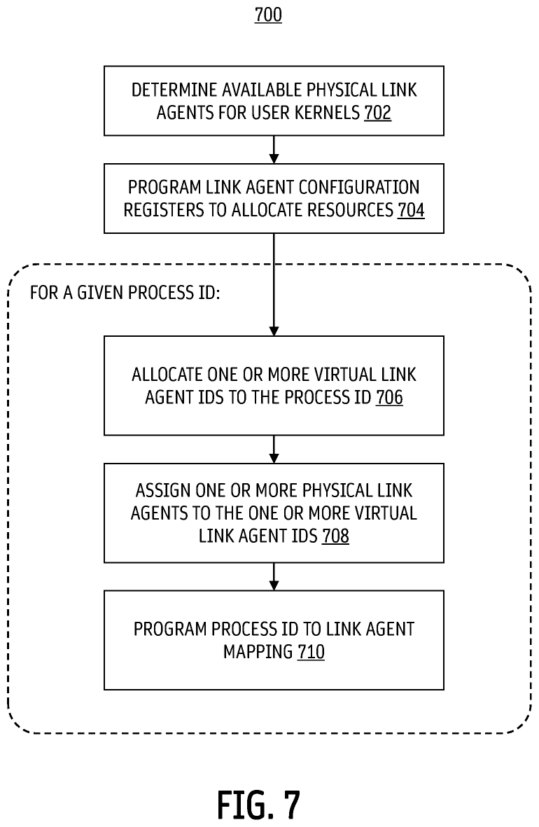

FIG. 7 illustrates method 700 for performing start up operations associated with lifecycle management of data movement resources, such as data movement resources 160 illustrated in FIG. 1. Method 700 can be performed by trusted agent executing on control processor 120, illustrated in FIG. 6, by submission control 140, illustrated in FIG. 2, by data movement engine 106, illustrated in FIG. 1, or by a combination thereof. In some examples, one or more operations of method 700 can be omitted, reordered, repeated, or performed as part of initialization, application launch, context creation, workload scheduling, or resource allocation.

In 702, trusted agent executing on control processor 120, illustrated in FIG. 6, determines available physical link agents for user kernels. Performing operation 702 can include a discovery operation, a setting operation, or a combination thereof. For example, trusted agent executing on control processor 120 can discover which link agents 162, illustrated in FIG. 1, are present, enabled, assignable, reserved, allocated, available for user submissions, or associated with a particular resource pool. Additionally, or alternatively, trusted agent executing on control processor 120 can set, designate, reserve, or identify particular link agents 162 as available physical link agents for one or more user kernels based on firmware policy, application requirements, workload scheduling, resource partitioning, quality-of-service requirements, or system configuration. In some examples, operation 702 can include reading and/or writing configuration registers, status registers, link agent configuration registers, firmware allocation state, or resource availability information associated with data movement engine 106, illustrated in FIG. 1.

In 704, trusted agent executing on control processor 120 may program link agent configuration registers to allocate resources (e.g., if resources are not already allocated or insufficient resources were allocated). Performing operation 704 can include programming one or more configuration fields associated with link agents 162, illustrated in FIG. 1, such as mode fields, enablement fields, user mode fields, queue parameters, buffer parameters, scheduling parameters, priority parameters, channel associations, and resource allocation fields. In some examples, operation 704 can define which physical link agents are available for later mapping to virtual link agent identifiers used by user kernels.

For a given process ID, method 700 can perform operations 706, 708, and 710. The dashed box in FIG. 7 indicates that operations 706, 708, and 710 can be repeated for different process IDs, user kernels, requester identifiers, virtual link agent identifiers, contexts, applications, or workloads. In some examples, the process ID can correspond to process ID 306 illustrated in FIG. 3B and can function as a mapping key for associating a requester and a virtual link agent identifier with a physical link agent.

In 706, trusted agent executing on control processor 120 allocates one or more virtual link agent IDs to the process ID. Performing operation 706 can include assigning one or more virtual link agent identifiers that a user kernel can include in a later user submission request, such as the user submission request illustrated in FIG. 3A. In some examples, the virtual link agent IDs provide a virtual resource abstraction for the user kernel, so that the user kernel can request data movement using a virtual identifier without controlling the physical link agent assigned to the virtual identifier.

In 708, trusted agent executing on control processor 120 assigns one or more physical link agents to the one or more virtual link agent IDs. Performing operation 708 can include selecting one physical link agent for a virtual link agent ID, selecting multiple physical link agents for multiple virtual link agent IDs, assigning multiple virtual link agent IDs to a same physical link agent, or assigning physical link agents based on workload demand, resource availability, isolation requirements, priority, bandwidth, latency, and system policy. In some examples, the physical link agents can correspond to link agents 162 illustrated in FIG. 1.

In 710, trusted agent executing on control processor 120 programs the process ID to link agent mapping. Performing operation 710 can include writing mapping entries that associate a process ID with one or more assigned physical link agents. In some examples, the mapping entries can be stored in process ID to link agent mapping 212 illustrated in FIG. 2, and can later be used by resource mapping circuit 142 illustrated in FIG. 2 to validate a submission request and route the submission request to an authorized physical link agent. After operation 710, a user kernel can submit a request using an allocated virtual link agent ID, and data movement engine 106 illustrated in FIG. 1 can resolve the request using trusted-programmed mapping information rather than allowing the user kernel to directly select the physical link agent.

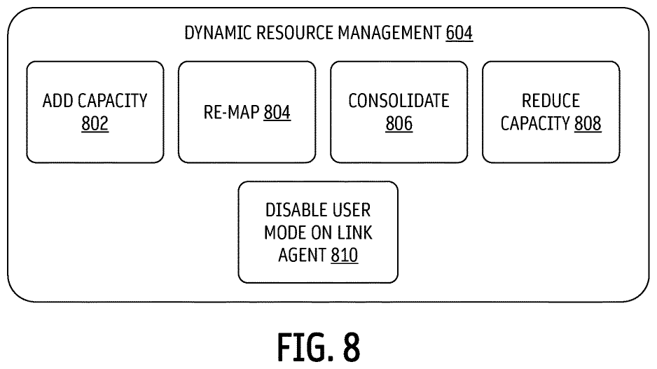

FIG. 8 illustrates implementations of dynamic resource management 604 during runtime, according to some examples of the disclosure. In some examples, dynamic resource management 604 can be performed by trusted agent executing on control processor 120, illustrated in FIG. 6, to modify how data movement resources 160, illustrated in FIG. 1, are assigned to requesters, process identifiers, virtual resource identifiers, user kernels, applications, or contexts during execution. In some examples, dynamic resource management 604 can be performed by reprogramming mapping information, link agent configuration registers 214, process ID to link agent mapping 212, or configuration registers 144, illustrated in FIG. 2. In some examples, dynamic resource management 604 can include one or more of add capacity 802, re-map 804, consolidate 806, reduce capacity 808, and disable user mode on link agent 810.

In some examples, add capacity 802 can include assigning an additional data movement resource to a requester during runtime. For example, if a user kernel initially has one virtual link agent identifier mapped to one physical link agent, trusted agent executing on control processor 120 can program an additional virtual link agent identifier or mapping entry so that another physical link agent becomes available to the same requester. This can increase available data movement bandwidth or parallelism without allowing the requester to directly select the physical link agent.

In some examples, re-map 804 can include changing an assignment from one data movement resource to another data movement resource during runtime. For example, trusted agent executing on control processor 120 can update process ID to link agent mapping 212, illustrated in FIG. 2, so that a virtual link agent identifier previously resolved to a first physical link agent instead resolves to a second physical link agent. Re-map 804 can be used when resources are rebalanced, a physical resource becomes unavailable, or a different resource is better suited for a workload.

In some examples, consolidate 806 can include mapping multiple virtual resource identifiers, process identifiers, requesters, or workloads to a shared data movement resource. For example, if two user kernels have low data movement demand, trusted agent executing on control processor 120 can program mapping information so that their respective virtual link agent identifiers resolve to the same physical link agent. Consolidate 806 can free another physical link agent for a higher-demand workload while preserving the virtual resource identifiers used by each user kernel.

In some examples, reduce capacity 808 can include removing one or more data movement resource assignments from a requester during runtime. For example, if a user kernel no longer requires high data movement bandwidth, trusted agent executing on control processor 120 can remove a mapping entry or change a mapping so that fewer physical link agents are available to the user kernel. Reduce capacity 808 can allow freed resources to be reassigned to another requester, workload, or context.

In some examples, disable user mode on link agent 810 can include changing a configuration field of a physical link agent so that the physical link agent no longer accepts user or untrusted submissions. For example, trusted agent executing on control processor 120 can update link agent configuration registers 214, illustrated in FIG. 2, to clear a user mode enable field for a selected link agent. After user mode is disabled, submission requests from an untrusted requester that would otherwise resolve to the selected link agent can be rejected, while trusted submissions may remain permitted depending on configuration.

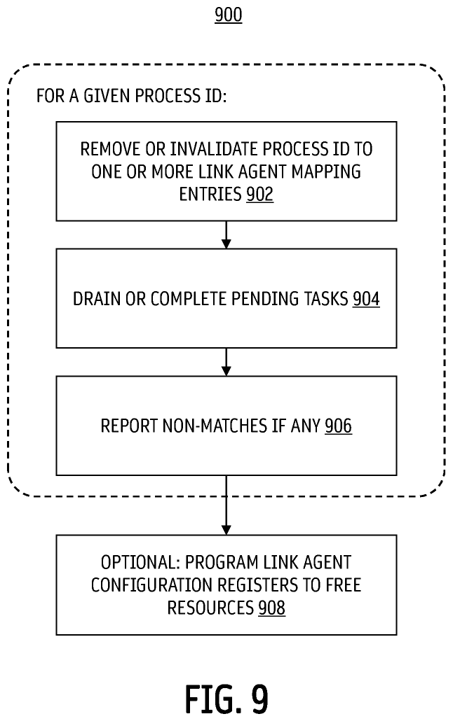

FIG. 9 illustrates method 900 for performing bring down operations associated with lifecycle management, according to some examples of the disclosure. Method 900 can be performed for a given process ID, as shown by the dashed box, and can be performed by trusted agent executing on control processor 120, illustrated in FIG. 6, using configuration and mapping structures of submission control 140, illustrated in FIG. 2. In some examples, one or more operations of method 900 can be omitted, reordered, delayed, repeated for multiple process IDs, or performed as part of application termination, context teardown, workload migration, error recovery, power management, or resource reallocation.

In 902, trusted agent executing on control processor 120 removes or invalidates one or more mapping entries that map a process ID to one or more link agents. Performing operation 902 can include deleting, disabling, marking invalid, masking, overwriting, or updating entries in process ID to link agent mapping 212, illustrated in FIG. 2. In some examples, removing or invalidating the mapping entries prevents later submission requests associated with the process ID from resolving to the corresponding physical link agents. Operation 902 can therefore revoke access to physical data movement resources without requiring the requester to modify the virtual link agent identifiers used by the requester.

In 904, trusted agent executing on control processor 120 drains or completes pending tasks. Performing operation 904 can include allowing already-accepted data movement tasks to complete, preventing new tasks from being accepted for the process ID, flushing queues, waiting for completion status, canceling selected pending tasks if permitted by system policy, or ensuring that data movement resources are placed in a known state. In some examples, operation 904 can be performed before or after invalidating mapping entries, depending on whether the system prioritizes immediate revocation, graceful completion, or error recovery.

In 906, data movement engine 106, illustrated in FIG. 1, reports (subsequent) non-matches if any. Performing operation 906 can include recording, in status registers 206 illustrated in FIG. 2, attempts to submit requests using a process ID whose mapping has been removed or invalidated. In some examples, operation 906 can include raising an interrupt to trusted agent executing on control processor 120, returning an error indication, updating a no-match indicator, or recording diagnostic information identifying the process ID, virtual link agent identifier, requester, or attempted resource access. Reporting non-matches can help trusted agent executing on control processor 120 detect stale submissions, late submissions, misbehaving requesters, or submissions that arrive after bring down has begun.

In 908, trusted agent executing on control processor 120 optionally programs link agent configuration registers to free resources. Performing operation 908 can include clearing an allocation field, clearing a user mode enable field, changing a resource mode, updating queue or buffer ownership, resetting scheduling state, changing resource availability, or returning a physical link agent to a free resource pool. In some examples, operation 908 can be omitted when resources remain reserved, when resource configuration has already been updated in operation 902, or when bring down is limited to invalidating mapping entries without changing physical resource configuration. After operation 908, the freed data movement resources can be reassigned during a later startup operation, such as method 700 illustrated in FIG. 7, or during dynamic resource management 604 illustrated in FIG. 8.

### Methods for Data Movement Engine Operation

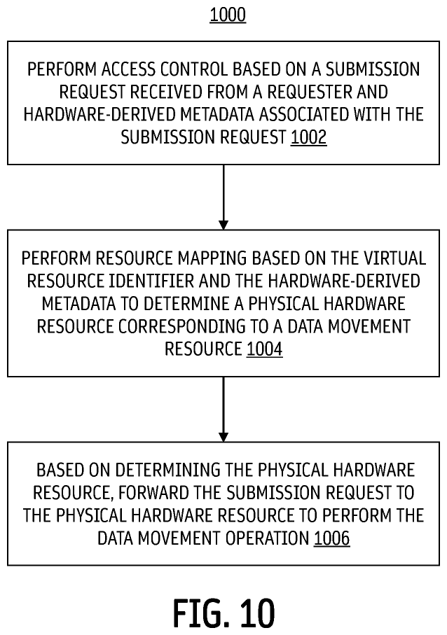

FIG. 10 is a flow diagram illustrating method 1000 for operating a data movement engine, e.g., data movement engine 106 as illustrated in FIGS. 1-2, according to some examples of the disclosure. Method 1000 can be performed by submission control 140 illustrated in FIG. 1, by access control circuit 146 illustrated in FIG. 2, by resource mapping circuit 142 illustrated in FIG. 2, by data movement resources 160 illustrated in FIG. 1, or by a combination thereof. In some examples, method 1000 can be performed for a submission request received from a requester, such as untrusted agent executing on programmable processor 130 illustrated in FIG. 1, and can use hardware-derived metadata associated with the submission request, such as submission metadata 302 illustrated in FIG. 3B.

In 1002, submission control 140 performs access control based on a submission request received from a requester and hardware-derived metadata associated with the submission request. Performing operation 1002 can include receiving a submission request that includes a virtual resource identifier and a task descriptor address, as illustrated in FIG. 3A, and evaluating hardware-derived metadata associated with the request, such as context ID 304 illustrated in FIG. 3B. In some examples, operation 1002 can include determining whether the context ID indicates a trusted context or an untrusted context, as illustrated in FIG. 4. For example, access control circuit 146 illustrated in FIG. 2 can permit a trusted or global context to access configuration registers 144 illustrated in FIG. 2, can restrict an untrusted or non-global context to push pointer register 202 illustrated in FIG. 2, and can disallow access to protected configuration resources.

In some examples, performing operation 1002 can also include handling an access control error. For example, if a requester attempts to access configuration registers 144, process ID to link agent mapping 212, link agent configuration registers 214, or another protected configuration resource that the requester is not permitted to access, access control circuit 146 can block the access. In some examples, access control circuit 146 can generate an error, write an indication of the error to status registers 206 illustrated in FIG. 2, raise an interrupt signal to trusted agent executing on control processor 120 illustrated in FIG. 6, or prevent the access from modifying protected configuration information.

In 1004, resource mapping circuit 142 performs resource mapping based on the virtual resource identifier and the hardware-derived metadata to determine a physical hardware resource corresponding to a data movement resource. Performing operation 1004 can include generating or identifying a process ID based on requester ID 310 and virtual link agent ID 320 illustrated in FIG. 3B. Performing operation 1004 can further include comparing the process ID to mapping information, such as process ID to link agent mapping 212 illustrated in FIG. 2, and determining whether the process ID corresponds to an authorized physical hardware resource. In some examples, operation 1004 can include consulting link agent configuration registers 214 illustrated in FIG. 2 to determine whether a mapped physical resource is enabled, available, configured for user submissions, or eligible to receive the submission request.

In some examples, performing operation 1004 can also include rejecting the submission request when no authorized physical hardware resource corresponds to the virtual resource identifier and hardware-derived metadata. For example, resource mapping circuit 142 can reject the submission request if no process ID to physical hardware resource mapping matches the generated process ID, if the mapped resource is disabled, or if the mapped resource is not configured to accept the submission request. In some examples, rejecting the submission request can include writing a rejection indication to status registers 206 illustrated in FIG. 2, raising an interrupt signal to trusted agent executing on control processor 120 illustrated in FIG. 6, and preventing the submission request from reaching data movement resources 160 illustrated in FIG. 1.

In 1006, based on determining the physical hardware resource, resource mapping circuit 142 forwards the submission request to the physical hardware resource to perform the data movement operation. In some examples, performing operation 1006 can include routing the submission request, the task descriptor address, a push indication, and related submission information to a selected link agent of link agents 162 illustrated in FIG. 1. In some examples, the selected link agent uses the task descriptor address to fetch or process a task descriptor and causes a channel in channels 164 illustrated in FIG. 1 to perform the data movement operation, such as transferring data between internal memory 104 and external memory interface 108 illustrated in FIG. 1. Thus, the requester can trigger data movement through a virtual resource identifier while physical resource selection remains governed by hardware-derived metadata and trusted-programmed mapping information.

In some examples, method 1000 can be used with lifecycle operations performed by trusted agent executing on control processor 120 illustrated in FIG. 6. For example, before operation 1004, trusted agent executing on control processor 120 can program mapping information during startup, as illustrated in FIG. 7. During runtime, trusted agent executing on control processor 120 can reprogram the mapping information to add, remove, re-map, consolidate, or revoke assignments of data movement resources, as illustrated in FIG. 8. During bring down, trusted agent executing on control processor 120 can invalidate mapping entries and free resources, as illustrated in FIG. 9. These lifecycle operations can change how virtual resource identifiers resolve to physical hardware resources while allowing a requester to continue using the virtual submission interface.

### Exemplary Computing Device

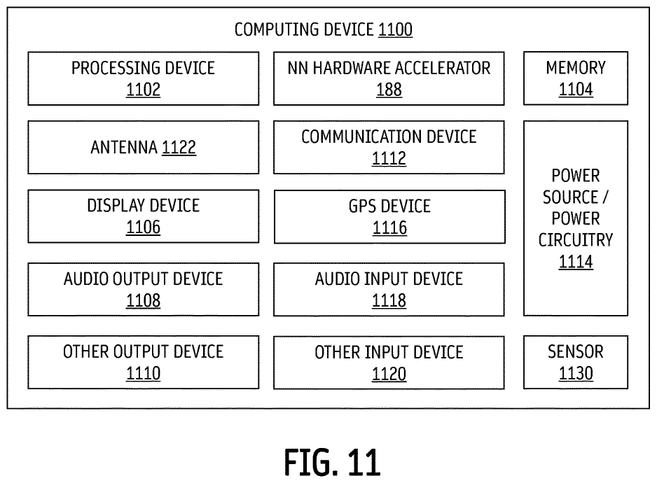

FIG. 11 is a block diagram of an apparatus or a system, e.g., an exemplary computing device 1100, according to some examples of the disclosure. One or more computing devices 1100 may be used to implement the functionalities described with the FIGS. and herein. A number of components are illustrated in the FIGS. that can be included in computing device 1100, but any one or more of these components may be omitted or duplicated, as suitable for the application. In some examples, some or all of the components included in computing device 1100 may be attached to one or more motherboards. In some examples, some or all of these components are fabricated onto a single system-on-chip die. Additionally, in various examples, computing device 1100 may not include one or more of the components illustrated in FIG. 11, and computing device 1100 may include interface circuitry for coupling to the one or more components. For example, computing device 1100 may not include a display device 1106, and may include display device interface circuitry (e.g., a connector and driver circuitry) to which a display device 1106 may be coupled. In another set of examples, computing device 1100 may not include an audio input device 1118 or an audio output device 1108 and may include audio input or output device interface circuitry (e.g., connectors and supporting circuitry) to which an audio input device 1118 or audio output device 1108 may be coupled.

Computing device 1100 may include a processing device 1102 (e.g., one or more processing devices, one or more of the same type of processing device, one or more of different types of processing devices). The processing device 1102 may include electronic circuitry that processes electronic data from data storage elements (e.g., registers, memory, resistors, capacitors, quantum bit cells) to transform that electronic data into other electronic data that may be stored in registers and/or memory. Examples of processing device 1102 may include a CPU, a GPU, a quantum processor, a machine learning processor, an artificial intelligence processor, a neural network processor, an artificial intelligence accelerator, an application-specific integrated circuit (ASIC), an analog signal processor, an analog computer, a microprocessor, a digital signal processor, a FPGA, a TPU, a data processing unit (DPU), etc.

In some examples, computing device 1100 may include NN hardware accelerator 188. NN hardware accelerator 188 can interface with processing device 1102 to accelerate inference, training, artificial intelligence, machine learning, graphics, signal processing, image processing, video processing, data processing, networking, security, compression, decompression, or suitable compute operations. In some examples, NN hardware accelerator 188 may be implemented as one or more of a neural network accelerator, artificial intelligence accelerator, machine learning accelerator, graphics processing unit, image signal processor, video processing unit, digital signal processor, data processing unit, infrastructure processing unit, network processing unit, security accelerator, cryptographic accelerator, compression accelerator, decompression accelerator, or suitable multi-tile or multi-agent processing device.

NN hardware accelerator 188 may include one or more components described with reference to FIGS. 1-2, 6, and 8. For example, NN hardware accelerator 188 may include one or more of: one or more compute engines 102, internal memory 104, data movement engine 106, external memory interface 108, submission control 140, access control circuit 146, resource mapping circuit 142, configuration registers 144, data movement resources 160, link agents 162, channels 164, trusted agent executing on control processor 120, untrusted agent executing on programmable processor 130, and dynamic resource management 604. In some examples, NN hardware accelerator 188 may include circuitry for receiving a submission request that includes a virtual resource identifier and a task descriptor address, performing access control based on hardware-derived metadata associated with the submission request, performing resource mapping based on the virtual resource identifier and the hardware-derived metadata, or forwarding the submission request to a physical hardware resource to perform a data movement operation. In some examples, one or more of these components may be implemented in NN hardware accelerator 188 as hardware logic, firmware-controlled hardware, programmable interconnect logic, register-transfer-level circuitry, state machines, microcoded control logic, fixed-function data movement circuitry, programmable processing circuitry, or combinations thereof.

Computing device 1100 may include a memory 1104, which may itself include one or more memory devices such as volatile memory (e.g., DRAM), nonvolatile memory (e.g., ROM), HBM, flash memory, solid-state memory, and/or a hard drive. Memory 1104 includes one or more non-transitory computer-readable storage media. In some examples, memory 1104 may include memory that shares a die with the processing device 1102.

In some examples, memory 1104 includes one or more non-transitory computer-readable media storing instructions executable to perform operations described with FIGS. 1-10 and herein. Memory 1104 may store instructions that generate inputs to NN hardware accelerator 188, such as neural network inputs, task descriptors, command streams, user submission requests, virtual resource identifiers, data movement requests, and configuration requests. Memory 1104 may store instructions that process outputs from NN hardware accelerator 188, such as output tensors, completion information, status information, rejection information, interrupt-handling information, and error information. In some examples, memory 1104 may store instructions that cause NN hardware accelerator 188, processing device 1102, a control processor, a programmable processor, a trusted agent, or an untrusted agent to perform one or more operations illustrated in FIGS. 1-10, including startup operations, access control operations, resource mapping operations, data movement operations, runtime resource management operations, bring down operations, and status/error handling operations. The instructions stored in the one or more non-transitory computer-readable media may be executed by processing device 1102.

In some examples, memory 1104 may store data, such as data structures, binary data, bits, metadata, files, blobs, register values, configuration values, mapping entries, task descriptors, linked lists of task descriptors, submission metadata, context identifiers, requester identifiers, process identifiers, virtual resource identifiers, status information, and error information, as described with FIGS. 1-10 and herein. Data may include inputs and outputs to NN hardware accelerator 188, such as input tensors, output tensors, input activations, output feature maps, weights of weight matrices, operation parameters, intermediate feature maps, model parameters, layer parameters, source addresses, destination addresses, transfer sizes, memory attributes, and data movement descriptors. In some examples, memory 1104 may store task descriptors identified by task descriptor addresses included in submission requests, and data movement engine 106 may use the task descriptors to move data between internal memory 104 and external memory accessible through external memory interface 108.

In some examples, computing device 1100 may include a communication device 1112 (e.g., one or more communication devices). For example, communication device 1112 may be configured for managing wired and/or wireless communications for the transfer of data to and from computing device 1100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not include any wires, although in some examples they might not. Communication device 1112 may implement any of a number of wireless standards or protocols. Computing device 1100 may include an antenna 1122 to facilitate wireless communications and/or to receive other wireless communications (such as radio frequency transmissions). Computing device 1100 may include receiver circuits and/or transmitter circuits. In some examples, the communication device 1112 may manage wired communications, such as electrical, optical, or any other suitable communication protocols (e.g., Ethernet). As noted above, the communication device 1112 may include multiple communication chips. For instance, a first communication device 1112 may be dedicated to shorter-range wireless communications, such as Wi-Fi or Bluetooth, and a second communication device 1112 may be dedicated to longer-range wireless communications. In some examples, a first communication device 1112 may be dedicated to wireless communications, and a second communication device 1112 may be dedicated to wired communications.

Computing device 1100 may include power source/power circuitry 1114. The power source/power circuitry 1114 may include one or more energy storage devices (e.g., batteries or capacitors) and/or circuitry for coupling components of computing device 1100 to an energy source separate from computing device 1100 (e.g., DC power, AC power, etc.).

Computing device 1100 may include a display device 1106 (or corresponding interface circuitry, as discussed above). The display device 1106 may include any visual indicators, such as a heads-up display, a computer monitor, a projector, a touchscreen display, a liquid crystal display (LCD), a light-emitting diode display, or a flat panel display, for example.

Computing device 1100 may include an audio output device 1108 (or corresponding interface circuitry, as discussed above). The audio output device 1108 may include any device that generates an audible indicator, such as speakers, headsets, or earbuds, for example.

Computing device 1100 may include an audio input device 1118 (or corresponding interface circuitry, as discussed above). The audio input device 1118 may include any device that generates a signal representative of a sound, such as microphones, microphone arrays, or digital instruments (e.g., instruments having a musical instrument digital interface (MIDI) output).

Computing device 1100 may include a GPS device 1116 (or corresponding interface circuitry, as discussed above). GPS device 1116 may be in communication with a satellite-based system and may receive a location of computing device 1100, as known in the art.

Computing device 1100 may include sensor 1130 (or one or more sensors). Computing device 1100 may include corresponding interface circuitry, as discussed above. Sensor 1130 may sense physical phenomena and translate the physical phenomenon into electrical signals that can be processed by, e.g., processing device 1102. Examples of sensor 1130 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 1100 may include another output device 1110 (or corresponding interface circuitry, as discussed above). Examples of the other output device 1110 may include an audio codec, a video codec, a printer, a wired or wireless transmitter for providing information to other devices, haptic output device, gas output device, vibrational output device, lighting output device, home automation controller, or an additional storage device.

Computing device 1100 may include another input device 1120 (or corresponding interface circuitry, as discussed above). Examples of the other input device 1120 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 1100 may have any desired form factor, such as a handheld or mobile computer system (e.g., a cell phone, a smartphone, a mobile Internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or suitable networked computing component, a printer, a scanner, a monitor, a set-top box, an entertainment control unit, a vehicle control unit, a digital camera, a digital video recorder, an Internet-of-Things device, or a wearable computer system. In some examples, computing device 1100 may be any other electronic device that processes data.

### SELECT EXAMPLES

Example 1 provides an apparatus, including access control circuitry to perform access control based on information in a submission request from a requester and hardware-derived metadata identifying the requester, where the information includes a virtual resource identifier and a task descriptor address for a data movement operation between a memory and a further memory accessible by a compute engine of a neural network accelerator; and resource mapping circuitry to: perform a determination of a physical hardware resource corresponding to a data movement resource based on the virtual resource identifier and the hardware-derived metadata; and based on the determination, forward the submission request to the physical hardware resource to perform the data movement operation.

Example 2 provides the apparatus of example 1, where: the hardware-derived metadata includes a context identifier; and the access control circuitry is to determine whether the submission request is associated with a trusted context or an untrusted context based on the context identifier.

Example 3 provides the apparatus of example 2, where the access control circuitry is further to: based on determining that the submission request is associated with the untrusted context, restrict the requester to submitting the task descriptor address and the virtual resource identifier to a push pointer register.

Example 4 provides the apparatus of example 2 or 3, where the access control circuitry is further to: based on determining that the submission request is associated with the untrusted context, disallow the requester from accessing one or more configuration registers.

Example 5 provides the apparatus of any one of examples 1-4, where: the hardware-derived metadata includes a requester identifier; and the resource mapping circuitry is to perform the determination based on a process identifier generated based on the requester identifier and the virtual resource identifier.

Example 6 provides the apparatus of any one of examples 1-5, where: the resource mapping circuitry is to perform the determination using mapping information that is programmed by a trusted agent and is inaccessible to the requester.

Example 7 provides the apparatus of any one of examples 1-6, where: the resource mapping circuitry is to perform the determination based on a process identifier to physical hardware resource mapping that associates a process identifier with the physical hardware resource.

Example 8 provides the apparatus of any one of examples 1-7, where: the access control circuitry is to generate an error based on the requester attempting to access a configuration resource that the requester is not permitted to access.

Example 9 provides the apparatus of any one of examples 1-8, where: the resource mapping circuitry is to reject the submission request based on determining, using the virtual resource identifier and the hardware-derived metadata, that no physical hardware resource corresponding to the virtual resource identifier is authorized for the requester.

Example 10 provides the apparatus of example 9, where the resource mapping circuitry is to write to a status register to indicate that the submission request was rejected.

Example 11 provides the apparatus of example 9 or 10, where the resource mapping circuitry is to raise an interrupt signal to notify a trusted agent to indicate that the submission request was rejected.

Example 12 provides a neural network hardware accelerator, including one or more compute engines to perform one or more neural network operations; an internal memory accessible to the one or more compute engines; an external memory interface; a processor to execute an agent; a data movement engine coupled to the internal memory and the external memory interface; and a submission control circuitry to perform access control and resource mapping based on information in a submission request received from the agent and hardware-derived metadata identifying the agent, where the information includes a virtual resource identifier and a task descriptor address for a data movement operation to be performed by the data movement engine, and the data movement operation moves tensor data for the one or more neural network operations between the internal memory and the external memory interface.

Example 13 provides the neural network hardware accelerator of example 12, further including a control processor to execute a trusted agent, where the trusted agent is to program mapping information used by the submission control circuitry to perform the resource mapping.

Example 14 provides the neural network hardware accelerator of example 12 or 13, where: the hardware-derived metadata includes a context identifier; and the submission control circuitry is to perform the access control based on the context identifier.

Example 15 provides the neural network hardware accelerator of example 14, where: the submission control circuitry is to restrict the agent to submitting the task descriptor address through a push pointer register based on the context identifier indicating an untrusted context.

Example 16 provides the neural network hardware accelerator of any one of examples 12-15, where: the hardware-derived metadata includes a requester identifier; and the submission control circuitry is to perform the resource mapping based on a process identifier generated based on the requester identifier and the virtual resource identifier.

Example 17 provides the neural network hardware accelerator of any one of examples 12-16, where: the submission control circuitry is to generate an error based on the agent attempting to access a configuration resource that the agent is not permitted to access.

Example 18 provides the neural network hardware accelerator of any one of examples 12-17, where: the submission control circuitry is to reject the submission request based on determining that no physical hardware resource corresponding to the virtual resource identifier is authorized for the agent.

Example 19 provides a method, including performing access control based on a submission request received from a requester and hardware-derived metadata associated with the submission request, where the submission request includes a virtual resource identifier and a task descriptor address for a data movement operation, the hardware-derived metadata identifies the requester, and the data movement operation moves tensor data between a memory and a further memory accessible by a compute engine of a neural network accelerator; performing resource mapping based on the virtual resource identifier and the hardware-derived metadata to determine a physical hardware resource corresponding to a data movement resource; and based on determining the physical hardware resource, forwarding the submission request to the physical hardware resource to perform the data movement operation.

Example 20 provides the method of example 19, where: the hardware-derived metadata includes a context identifier; and performing the access control includes determining whether the submission request is associated with a trusted context or an untrusted context based on the context identifier.

Example 21 provides the method of example 20, further including based on determining that the submission request is associated with the untrusted context, restricting the requester to submitting the task descriptor address and the virtual resource identifier through a push pointer register.

Example 22 provides the method of example 20 or 21, further including based on determining that the submission request is associated with the untrusted context, disallowing the requester from accessing one or more configuration registers.

Example 23 provides the method of any one of examples 20-22, where: the hardware-derived metadata includes a requester identifier; and performing the resource mapping includes generating a process identifier based on the requester identifier and the virtual resource identifier.

Example 24 provides the method of example 23, where performing the resource mapping includes comparing the process identifier to mapping information that is programmed by a trusted agent and is inaccessible for writing by the requester.

Example 25 provides the method of example 24, where the mapping information includes a process identifier to physical hardware resource mapping that associates the process identifier with the physical hardware resource.

Example 26 provides the method of any one of examples 19-25, further including rejecting the submission request based on determining, using the virtual resource identifier and the hardware-derived metadata, that no physical hardware resource corresponding to the virtual resource identifier is authorized for the requester.

Example 27 provides the method of example 26, further including writing to a status register to indicate that the submission request was rejected.

Example 28 provides the method of example 26 or 27, further including raising an interrupt signal to notify a trusted agent that the submission request was rejected.

Example 29 provides the method of any one of examples 19-28,further including generating an error based on the requester attempting to access a configuration resource that the requester is not permitted to access.

Example 30 provides the method of example 29, further including writing to a status register or raising an interrupt signal based on the error.

Example 31 provides the method of any one of examples 19-30,further including programming, by a trusted agent, mapping information used to perform the resource mapping.

Example 32 provides the method of example 31, further including reprogramming, by the trusted agent during runtime, the mapping information to change an assignment of a data movement resource to the requester. <b></b>

Example 33 provides the method of example 32, where changing the assignment includes adding an assignment of an additional data movement resource to the requester.

Example 34 provides the method of example 32 or 33, where changing the assignment includes removing an assignment of a data movement resource from the requester.

Example 35 provides the method of any one of examples 32-34, where changing the assignment includes re-mapping the requester from a data movement resource to a further data movement resource.

Example 36 provides the method of any one of examples 32-35, where changing the assignment includes consolidating a plurality of virtual resource identifiers associated with the requester to a same data movement resource.

Example 37 provides the method of any one of examples 32-36, where changing the assignment includes revoking an assignment of the data movement resource to the requester.

Example 38 provides the method of any one of examples 31-37, further including invalidating, by the trusted agent, an entry of mapping information used in performing the resource mapping to revoke access by the requester to the physical hardware resource.

### Variations and Other Notes

Although the operations of the example method shown in and described with reference to FIGS. are illustrated as occurring once each and in a particular order, it will be recognized that some operations may be performed in any suitable order and repeated as desired. Furthermore, the operations illustrated in FIGS. may be combined or may include more or fewer details than described.

The various implementations described herein may refer to AI, machine learning, and deep learning. Deep learning may be a subset of machine learning. Machine learning may be a subset of AI. In cases where a deep learning model is mentioned, if suitable for a particular application, a machine learning model may be used instead. In cases where a deep learning model is mentioned, if suitable for a particular application, a digital signal processing system may be used instead.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which are shown, by way of illustration, examples that may be practiced. It is to be understood that other examples may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order-dependent. In particular, these operations may not be performed in the order of presentation. Operations described may be performed in a different order from the described example. Various additional operations may be performed or described operations may be omitted in additional examples.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

For the purposes of the present disclosure, “A is less than or equal to a first threshold” is equivalent to “A is less than a second threshold” provided that the first threshold and the second threshold are set in a manner so that both statements result in the same logical outcome for any value of A. For the purposes of the present disclosure, “B is greater than a first threshold” is equivalent to “B is greater than or equal to a second threshold” provided that the first threshold and the second threshold are set in a manner so that both statements result in the same logical outcome for any value of B.

The description uses the phrases “in an example” or “in examples,” which may each refer to one or more of the same or different examples. The terms “comprising,” “including,” “having,” and the like, as used with respect to examples of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking, or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An apparatus, comprising:
access control circuitry to perform access control based on information in a submission request from a requester and hardware-derived metadata identifying the requester, wherein the information comprises a virtual resource identifier and a task descriptor address for a data movement operation between a memory and a further memory accessible by a compute engine of a neural network accelerator; and
resource mapping circuitry to:
perform a determination of a physical hardware resource corresponding to a data movement resource based on the virtual resource identifier and the hardware-derived metadata; and
based on the determination, forward the submission request to the physical hardware resource to perform the data movement operation.

2. The apparatus of claim 1, wherein:
the hardware-derived metadata comprises a context identifier; and
the access control circuitry is to determine whether the submission request is associated with a trusted context or an untrusted context based on the context identifier.

3. The apparatus of claim 2, wherein the access control circuitry is further to:
based on determining that the submission request is associated with the untrusted context, restrict the requester to submitting the task descriptor address and the virtual resource identifier to a push pointer register.

4. The apparatus of claim 2, wherein the access control circuitry is further to:
based on determining that the submission request is associated with the untrusted context, disallow the requester from accessing one or more configuration registers.

5. The apparatus of claim 1, wherein:
the hardware-derived metadata comprises a requester identifier; and
the resource mapping circuitry is to perform the determination based on a process identifier generated based on the requester identifier and the virtual resource identifier.

6. The apparatus of claim 1, wherein:
the resource mapping circuitry is to perform the determination using mapping information that is programmed by a trusted agent and is inaccessible to the requester.

7. The apparatus of claim 1, wherein:
the resource mapping circuitry is to perform the determination based on a process identifier to physical hardware resource mapping that associates a process identifier with the physical hardware resource.

8. The apparatus of claim 1, wherein:
the access control circuitry is to generate an error based on the requester attempting to access a configuration resource that the requester is not permitted to access.

9. The apparatus of claim 1, wherein:
the resource mapping circuitry is to reject the submission request based on determining, using the virtual resource identifier and the hardware-derived metadata, that no physical hardware resource corresponding to the virtual resource identifier is authorized for the requester.

10. The apparatus of claim 9, wherein the resource mapping circuitry is to write to a status register to indicate that the submission request was rejected.

11. The apparatus of claim 9, wherein the resource mapping circuitry is to raise an interrupt signal to notify a trusted agent to indicate that the submission request was rejected.

12. A neural network hardware accelerator, comprising:
one or more compute engines to perform one or more neural network operations;
an internal memory accessible to the one or more compute engines;
an external memory interface;
a processor to execute an agent;
a data movement engine coupled to the internal memory and the external memory interface; and
a submission control circuitry to perform access control and resource mapping based on information in a submission request received from the agent and hardware-derived metadata identifying the agent, wherein the information includes a virtual resource identifier and a task descriptor address for a data movement operation to be performed by the data movement engine; and the data movement operation moves tensor data for the one or more neural network operations between the internal memory and the external memory interface.

13. The neural network hardware accelerator of claim 12, further comprising:
a control processor to execute a trusted agent, wherein the trusted agent is to program mapping information used by the submission control circuitry to perform the resource mapping.

14. The neural network hardware accelerator of claim 12, wherein:
the hardware-derived metadata comprises a context identifier; and
the submission control circuitry is to perform the access control based on the context identifier.

15. The neural network hardware accelerator of claim 14, wherein:
the submission control circuitry is to restrict the agent to submitting the task descriptor address through a push pointer register based on the context identifier indicating an untrusted context.

16. The neural network hardware accelerator of claim 12, wherein:
the hardware-derived metadata comprises a requester identifier; and
the submission control circuitry is to perform the resource mapping based on a process identifier generated based on the requester identifier and the virtual resource identifier.

17. The neural network hardware accelerator of claim 12, wherein:
the submission control circuitry is to generate an error based on the agent attempting to access a configuration resource that the agent is not permitted to access.

18. The neural network hardware accelerator of claim 12, wherein:
the submission control circuitry is to reject the submission request based on determining that no physical hardware resource corresponding to the virtual resource identifier is authorized for the agent.

19. A method, comprising:
performing access control based on a submission request received from a requester and hardware-derived metadata associated with the submission request, wherein the submission request includes a virtual resource identifier and a task descriptor address for a data movement operation, the hardware-derived metadata identifies the requester; and the data movement operation moves tensor data between a memory and a further memory accessible by a compute engine of a neural network accelerator;
performing resource mapping based on the virtual resource identifier and the hardware-derived metadata to determine a physical hardware resource corresponding to a data movement resource; and
based on determining the physical hardware resource, forwarding the submission request to the physical hardware resource to perform the data movement operation.

20. The method of claim 19, wherein:
the hardware-derived metadata comprises a context identifier; and
performing the access control comprises determining whether the submission request is associated with a trusted context or an untrusted context based on the context identifier.
